(19) United States
(12) Patent Application Publication
(10) Pub. No.: US 2024/0095103 A1
(43) Pub. Date: Mar. 21, 2024

(54) System and Method for Synchronising Access to Shared Memory

(71) Applicant: Graphcore Limited, Bristol (GB)

(72) Inventors: Lars Paul HUSE, Oppegaard (NO); Uberto GIROLA, Cambridge (GB); Bjorn Dag JOHNSEN, Oslo (NO)

(21) Appl. No.: 18/458,327

(22) Filed: Aug. 30, 2023

(30) Foreign Application Priority Data
Sep. 16, 2022 (GB) 2213607.1

(51) Int. Cl. G06F 9/54; G06F 9/38

(52) U.S. Cl. CPC G06F 9/544; G06F 9/3836

(57) ABSTRACT

A read and notify request is issued by a first processing unit to a lock manager on a different chip. A lock manager determines whether a condition specified by the request in relation to a variable for controlling access to a memory buffer is met. If the two are not equal, a notification request is registered until the variable changes. The second processing unit accesses the memory buffer and, when it has finished, updates the variable. If the variable then satisfies the condition specified by the read and notify request, the first processing unit is then notified by the lock manager and accesses the memory buffer. In this way, the first processing unit does not need to continually poll to determine when the variable has changed, but is notified when it is its turn to access the memory buffer.

### CROSS-REFERENCE TO RELATED APPLICATIONS

The present application claims priority to United Kingdom Patent Application No. GB2213607.1 filed on Sep. 16, 2022, the disclosure of which is incorporated by reference in its entirety.

### TECHNICAL FIELD

The present disclosure relates to a system comprising a plurality of processing units and a shared memory, and in particular to the use of a variable for controlling access to the shared memory.

### BACKGROUND

In the context of processing data for complex or high volume applications, a processing unit for performing the processing of that data may be provided. The processing unit may function as a work accelerator to which processing of certain data is offloaded from a host system. Such a processing unit may have specialised hardware for performing specific types of processing.

As an example, one area of computing in which such a specialised accelerator subsystem may be of use is found in machine intelligence. As will be familiar to those skilled in the art of machine intelligence, a machine intelligence algorithm is based around performing iterative updates to a “knowledge model”, which can be represented by a graph of multiple interconnected nodes. The implementation of each node involves the processing of data, and the interconnections of the graph correspond to data to be exchanged between the nodes. Typically, at least some of the processing of each node can be carried out independently of some or all others of the nodes in the graph, and therefore large graphs expose great opportunities for multi-threading. Therefore, a processing unit specialised for machine intelligence applications may comprise a large degree of multi-threading. One form of parallelism can be achieved by means of an arrangement of multiple tiles on the same chip, each tile comprising its own separate respective execution unit and memory (including program memory and data memory). Thus separate portions of program code can be run in parallel on different ones of the tiles.

In order to increase processing capacity, a plurality of processing units may be connected together to provide a scaled system. In such scaled systems, the connected processing units may be provided on different chips (i.e. different integrated circuits). The processing units in such a scaled system may have access to a shared memory for storing application data. During running of the application on the system of processing units, the application data held in shared memory may be read, modified, and written by the processing units. The shared memory may be used to exchange data between the processing units.

When implementing a shared memory accessible to multiple processing units, it may be required to provide a way of synchronising the access of the processing units to the shared memory in order to prevent out of order or concurrent access by the processing units to the same part of the memory. One approach to prevent concurrent access to a shared resource by threads, is to use locks, which protect access to critical sections of code associated with the memory access.

### SUMMARY

One approach to implementing a lock is for threads to wait (“spin”) in a lock whilst repeatedly checking whether the lock is available. The first thread to acquire the lock will execute its critical section of code, whilst the remaining threads continue to repeatedly check whether the lock is available. When the resource to be accessed is a memory buffer shared between multiple processing units on different chips, this has certain disadvantages. Firstly, out of order accesses to the memory buffer cannot be guaranteed. Once one processing unit has released the lock, the next processor to acquire the lock will simply be the next one to check whether the lock is available. Secondly, requiring a processing unit to continually check whether the lock is available before acquiring access introduces additional traffic into the system, since the processing unit must issue request packets to acquire the lock and wait for a response, before it can access the memory buffer. The request packets must be sent between the chips via chip-to-chip links (e.g. via ethernet links) and, therefore, the latency between the processing units and the memory controller is substantial, hence generating a substantial amount of additional traffic in the system.

According to a first aspect, there is provided a data processing system comprising: a first integrated circuit comprising a first processing unit; a second integrated circuit comprising a second processing unit; a shared memory shared by the first processing unit and the second processing unit; and a third integrated circuit comprising: a memory controller for accessing the shared memory; a storage holding a first variable for controlling access to a buffer of the memory; and circuitry for managing the first variable, wherein the first processing unit is configured to issue a first request packet to the circuitry, the first request packet specifying a condition in relation to the first variable, wherein the circuitry of the memory controller is configured to, in response to determining that the first variable does not meet the condition, wait until the first variable changes, wherein the second processing unit is configured to, prior to the first variable meeting the condition: issue one or more memory access request packets to access the buffer of the memory; and subsequently, issue a second request packet to cause updating of the first variable to meet the condition, wherein the circuitry of the memory controller is configured to, in response to the updating of the first variable, return a notification to the first processing unit, wherein the first processing unit is configured to, in response to the notification, issue a further one or more memory access request packets access the buffer of the memory.

The first request packet, which is issued by the first processing unit, may be referred to as a read and notify request. When the circuitry for managing the first variable receives such a request, it determines whether the first variable meets a condition specified by the request (e.g. whether the first variable is equal to a compare value specified in the request). If the first variable does not meet the condition, the circuitry waits until the first variable changes. In the meantime, the second processing unit may access the memory buffer and, when it has finished, update the first variable such that it meets the condition specified in the first request packet. The first processing unit is then notified and accesses the memory buffer. By ensuring that the first processing unit does not access the buffer until the second processing unit has updated the first variable to meet the condition, this scheme ensures that the processing units are synchronised, such that the second processing unit accesses the memory buffer before the first processing unit. Furthermore, the first processing unit does not need to continually poll to determine when the first variable has changed, but is notified when it is its turn to access the memory buffer. In one example, the second processing unit may transfer data to the first processing unit by writing data to the buffer, with the first processing unit reading data from that buffer. The synchronisation scheme ensures that the second processing unit writes its data to the buffer, prior to the first processing unit sending read requests to read the data from that buffer.

In some embodiments, the third integrated circuit is configured to interface with both the first integrated circuit and the second integrated circuit via ethernet links.

In some embodiments, the condition in relation to the first variable is that the first variable is equal to a compare value contained in the first request packet.

In some embodiments, the condition is that the first variable is not equal to a compare value contained in the first request packet.

In some embodiments, the condition is that the first variable is updated to a new value.

In some embodiments, the second request packet comprises a request for an atomic compare and swap operation, the second request packet comprising a further compare value and a swap value, the swap value being equal to a first value, wherein the circuitry for managing the first variable is configured to, in response to the second request packet: compare a current value of the first variable to the further compare value; and in response to determining that the current value is equal to the further compare value, set the first variable equal to the first value.

In some embodiments, the second processing unit is configured to, prior to accessing the buffer, issue a request for a fetch and add operation to be performed with respect to a second variable held in the storage, wherein the circuitry is configured to, in response to the request for the fetch and add operation, return a current value of the second variable to the second processing unit and increment the second variable to set it equal to the first value, wherein the second processing unit is configured to provide the current value of the second variable as the further compare value in the second request packet.

In some embodiments, the second processing unit is configured to access the buffer of the memory by writing data to the buffer of the memory, wherein the first processing unit is configured to access the buffer of the memory by reading the data from the buffer of memory.

In some embodiments, the data processing system comprises a plurality of further processing units configured to write data to the buffer of the memory, the plurality of further processing units including the second processing unit, wherein each of the further processing units is configured to: write data to a different part of the buffer of the memory; and subsequently, issue a request to cause updating of the first variable.

In some embodiments, the first processing unit is configured to, for each of the parts of the buffer of memory: issue a request of a first type to the circuitry; subsequently, receive a notification from the circuitry; and in response to the respective notification, issue one or more read requests to read data from the respective part of the buffer of memory, wherein the first request packet comprises a request of the first type, wherein the circuitry is configured to generate the notification in response to the respective request of the first type.

In some embodiments, the first processing unit and the second processing unit are configured to participate in a barrier synchronisation, which separates compute phases of the processing units from an exchange phase of the processing units, wherein the first processing unit is configured to issue the first request packet and the further one or more memory access request packets during the exchange phase, wherein the second processing unit is configured to issue the one or more memory access request packets and the second request packet during the exchange phase.

In some embodiments, the first processing unit is configured to execute a first set of instructions so as to: perform computations on a first set of data; issue the first request packet; and issue the further one or more memory access request packets, wherein the second processing unit is configured to execute a second set of instructions so as to: perform computations on a second set of data; issue the second request packet; and issue the one or more memory access request packets, wherein the first set of instructions and the second set of instructions form part of an application.

In some embodiments, the second processing unit is configured to perform its computations on part of the second set of data to generate part of the first set of data, wherein the one or more memory access request packets comprise one or more write requests comprising the part of the first set of data, wherein the one or more memory access request packets comprise one or more read request packets, wherein the memory controller is configured to, in response to the one or more read request packets, return the part of the first set of data in one or more read completions.

In some embodiments, the memory controller comprises the circuitry for managing the first variable.

In some embodiments, the first variable is a non-binary variable represented by more than two bits.

In some embodiments, the first processing unit is a first tile belonging to a multi-tile processing unit formed on the first integrated circuit, wherein the second processing unit is a second tile belonging to a multi-tile processing unit formed on the second integrated circuit.

In some embodiments, the first variable comprises a pointer identifying a location in the buffer, wherein the notification comprises a value of the pointer, wherein the first processing unit is configured to, in response to the notification, issue a further one or more memory access request packets to access the buffer of the memory at the location identified by the value of the pointer.

In some embodiments, the storage comprises a plurality of variables for controlling access to different buffers of the shared memory, the plurality of variables comprising the first variable, wherein the circuitry is configured to, for each of the plurality of variables, implement atomic operations with respect to the respective variable.

In some embodiments, the second integrated circuit is connected to the third integrated circuit by one or more intermediate integrated circuits.

According to a second aspect, there is provided a method for synchronising access to a buffer of shared memory by a first processing unit, formed on a first integrated circuit, and a second processing unit, formed on a second integrated circuit, the method comprising: issuing from the first processing unit, a first request packet to circuitry on a third integrated circuit, the first request packet specifying a condition in relation to a first variable held in storage on the third integrated circuit; in response to determining that the first variable does not meet the condition, the circuitry waiting until the first variable changes; prior to the first variable meeting the condition: the second processing unit issuing one or more memory access request packets to a memory controller on the third integrated circuit to access the buffer of the memory; and subsequently, issuing from the second processing unit, a second request packet to the circuitry to cause updating of the first variable such that the condition is met; in response to the updating of the first variable, the circuitry returning a notification to the first processing unit; and in response to the notification, the first processing unit issuing a further one or more memory access request packets to the memory controller to access the buffer of the memory.

In some embodiments, the third integrated circuit is configured to interface with both the first integrated circuit and the second integrated circuit via ethernet links.

In some embodiments, the condition in relation to the first variable is that the first variable is equal to a compare value contained in the first request packet.

In some embodiments, the condition is that the first variable is not equal to a compare value contained in the first request packet.

In some embodiments, the condition is that the first variable is updated to a new value.

In some embodiments, the second request packet comprises a request for an atomic compare and swap operation, the second request packet comprising a further compare value and a swap value, the swap value being equal to a first value, wherein the method further comprises the circuitry, in response to the second request packet: comparing a current value of the first variable to the further compare value; and in response to determining that the current value is equal to the further compare value, setting the first variable equal to the first value.

In some embodiments, the method further comprises prior to accessing the buffer, the second processing unit issuing a request for a fetch and add operation to be performed with respect to a second variable held in the storage; in response to the request for the fetch and add operation, returning a current value of the second variable to the second processing unit and incrementing the second variable to set it equal to the first value, wherein the method comprises, the second processing unit providing the current value of the second variable as the further compare value in the second request packet.

In some embodiments, the method further comprises the second processing unit accessing the buffer of the memory by writing data to the buffer of the memory; the first processing unit accessing the buffer of the memory by reading the data from the buffer of memory.

In some embodiments, the method comprises each of a plurality of further processing units writing data to the buffer of the memory, the plurality of further processing units including the second processing unit; and each of the further processing units writing data to a different part of the buffer of the memory; and subsequently, issuing a request to cause updating of the first variable.

In some embodiments, the method comprises, for each of the parts of the buffer of memory, the first processing unit issuing a request of a first type to the circuitry; subsequently, receiving a notification from the circuitry; and in response to the respective notification, issuing one or more read requests to read data from the respective part of the buffer of memory, wherein the first request packet comprises a request of the first type, wherein the method comprises the circuitry generating the notification in response to the respective request of the first type.

In some embodiments, the method comprises the first processing unit and the second processing unit participating in a barrier synchronisation, which separates compute phases of the processing units from an exchange phase of the processing units; the first processing unit issuing the first request packet and the further one or more memory access request packets during the exchange phase; and the second processing unit issuing the one or more memory access request packets and the second request packet during the exchange phase.

In some embodiments, the method comprises the first processing unit executing a first set of instructions so as to: perform computations on a first set of data; issue the first request packet; and issue the further one or more memory access request packets; and the second processing unit executing a second set of instructions so as to: perform computations on a second set of data; issue the second request packet; and issue the one or more memory access request packets, wherein the first set of instructions and the second set of instructions form part of an application.

In some embodiments, the method comprises the second processing unit performing its computations on part of the second set of data to generate part of the first set of data, wherein the one or more memory access request packets comprise one or more write requests comprising the part of the first set of data, wherein the one or more memory access request packets comprise one or more read request packets, wherein the method comprises, the memory controller, in response to the one or more read request packets, returning the part of the first set of data in one or more read completions.

In some embodiments, the memory controller comprises the circuitry for managing the first variable.

In some embodiments, the first variable is a non-binary variable represented by more than two bits.

In some embodiments, the first processing unit is a first tile belonging to a multi-tile processing unit formed on the first integrated circuit, wherein the second processing unit is a second tile belonging to a multi-tile processing unit formed on the second integrated circuit.

In some embodiments, the first variable comprises a pointer identifying a location in the buffer, wherein the notification comprises a value of the pointer, wherein the method comprises the first processing unit, in response to the notification, issuing a further one or more memory access request packets to access the buffer of the memory at the location identified by the value of the pointer.

In some embodiments, the storage comprises a plurality of variables for controlling access to different buffers of the shared memory, the plurality of variables comprising the first variable, wherein the method comprises the circuitry, for each of the plurality of variables, implementing atomic operations with respect to the respective variable.

In some embodiments, the second integrated circuit is connected to the third integrated circuit by one or more intermediate integrated circuits.

### BRIEF DESCRIPTION OF DRAWINGS

To assist understanding of the present disclosure and to show how embodiments may be put into effect, reference is made by way of example to the accompanying drawings in which:

FIG. 1 illustrates an example of a chip comprising a plurality of tile processing units;

FIG. 2 illustrates an example of a tile;

FIG. 3 illustrates a system comprising a plurality of chips, including a fabric chip and processor chips;

FIG. 4 illustrates circuitry within a memory interface for handling packets received from the processing units;

FIG. 5 illustrates steps performed to synchronise the memory accesses of two processing units;

FIG. 6 illustrates a set of pointers to different parts of a memory buffer, where those pointers are used to synchronise access to the buffer by writing processing units and a reading processing unit;

FIG. 7 illustrates steps performed to synchronise read and write access by multiple processing units to a buffer;

FIG. 8 illustrates how the local programs for running on each of the processing units are compiled from source code;

FIG. 9 is a schematic diagram illustrating compute and exchange phases within a multi-tile processing unit;

FIG. 10 illustrates exchange of data in a bulk synchronous parallel system;

FIG. 11 is a schematic illustration of internal and external synchronisation barriers;

FIG. 12 is an illustration of the combination of a BSP synchronisation scheme with the synchronisation scheme implemented by the lock manager; and

FIG. 13 is an example of a method according to embodiments of the application.

### DETAILED DESCRIPTION

Embodiments are implemented in a data processing system comprising a plurality of processing units. Each of these processing units may take the form of a tile of a multi-tile processing unit formed on a chip. Such a processing unit is described in more detail in U.S. application Ser. No. 16/276,834, which is incorporated by reference.

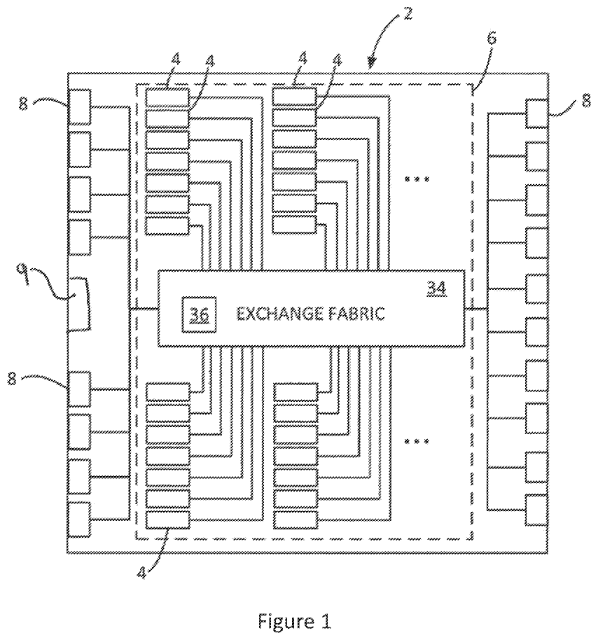

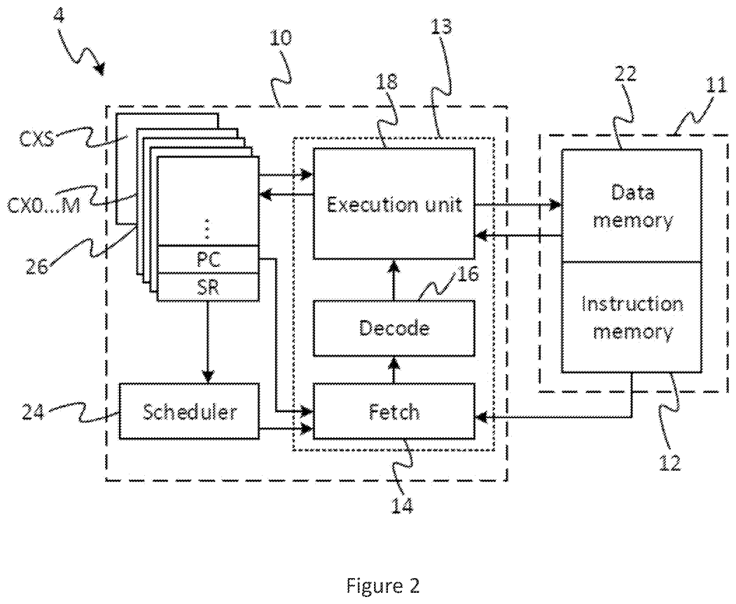

Reference is made to FIG. 1, which illustrates an example of a multi-tile processing unit 6 implemented on an integrated circuit 2 (i.e. a chip 2). The processing unit 6 comprises an array of multiple processing tiles 4 and an interconnect 34 connecting between the tiles 4. The interconnect 34 may also be referred to herein as the “exchange fabric” 34 as it enables the tiles 4 to exchange data with one another. As described below with respect to FIG. 2, each tile 4 comprises a respective instance of a processing unit and memory. For instance, by way of illustration, the processing unit 2 may comprise of the order of hundreds of tiles 4, or even over a thousand. For completeness, note also that an “array” as referred to herein does not necessarily imply any particular number of dimensions or physical layout of the tiles 4.

In embodiments, each chip 2 also comprises one or more external links 8, enabling the chip 2 to be connected to one or more other chips 2 (e.g. one or more other instances of the same chip 2). These external links 8 may comprise any one or more of: one or more processing unit-to-host links for connecting the chip 2 to a host processing node, and/or one or more chip-to-chip links for connecting together with one or more other instances of the chip 2 on the same IC package or card, or on different cards. In one example arrangement, the chip 2 receives work from a host processing node (not shown), which is connected to the chip 2 via one of the chip-to-host links in the form of input data to be processed by the chip 2. Multiple instances of the chip 2 can be connected together into cards by chip-to-chip links. Thus a host accesses a computer, which is architected as a multi-tile system on a chip 2, depending on the workload required for the host application.

FIG. 1 illustrates that a chip 2 comprising a single processing unit 6 provided on a single die. However, in some embodiments, multiple such processing units 6 may be formed in a 3-dimensional integrated circuit device (i.e. an integrated circuit device comprising stacked die), where different ones of those processing units 6 are formed on different ones of the stacked die.

Reference is made to FIG. 2, which illustrates an example of a tile 4 in accordance with embodiments of the present disclosure.

The tile 4 comprises a multi-threaded processing unit 10 in the form of a barrel-threaded processing unit, and a local memory 11 (i.e. on the same tile in the case of a multi-tile array, or same chip in the case of a single-processor chip). A barrel-threaded processing unit 10 is a type of multi-threaded processing unit in which the execution time of the pipeline is divided into a repeating sequence of interleaved time slots, each of which can be owned by a given thread. The memory 11 comprises an instruction memory 12 and a data memory 22 (which may be implemented in different addressable memory unit or different regions of the same addressable memory unit). The instruction memory 12 stores machine code to be executed by the processing unit 10, whilst the data memory 22 stores both data to be operated on by the executed code and data output by the executed code (e.g. as a result of such operations). The code contained in the instruction memory 12 is application code for an application that is executed at least partly on the tile 4.

The memory 12 stores a variety of different threads of a program, each thread comprising a respective sequence of instructions for performing a certain task or tasks. Note that an instruction as referred to herein means a machine code instruction, i.e. an instance of one of the fundamental instructions of the processor's instruction set, consisting of a single opcode and zero or more operands.

The processing unit 10 interleaves execution of a plurality of worker threads, and a supervisor subprogram, which may be structured as one or more supervisor threads. In embodiments, each of some or all of the worker threads takes the form of a respective “codelet”. A codelet is a particular type of thread, sometimes also referred to as an “atomic” thread. It has all the input information it needs to execute from the beginning of the thread (from the time of being launched), i.e. it does not take any input from any other part of the program or from memory after being launched. Further, no other part of the program will use any outputs (results) of the thread until it has terminated (finishes). Unless it encounters an error, it is guaranteed to finish. (N.B. some literature also defines a codelet as being stateless, i.e. if run twice it could not inherit any information from its first run, but that additional definition is not adopted here. Note also that not all of the worker threads need be codelets (atomic), and in embodiments some or all of the workers may instead be able to communicate with one another).

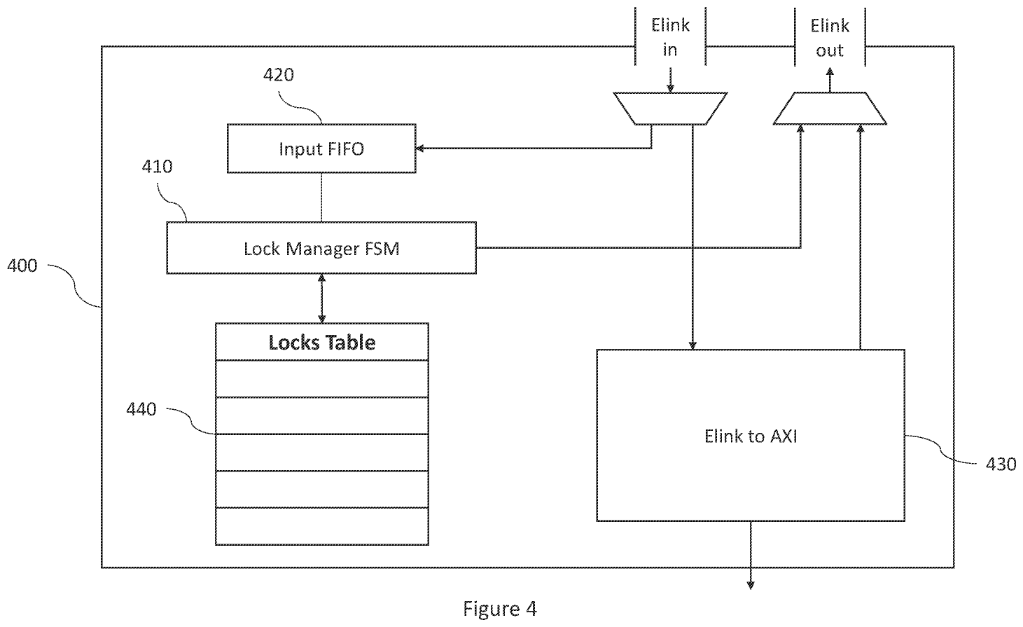

Within the processing unit 10, multiple different ones of the threads from the instruction memory 12 can be interleaved through a single execution pipeline 13 (though typically only a subset of the total threads stored in the instruction memory can be interleaved at any given point in the overall program). The multi-threaded processing unit 10 comprises: a plurality of context register files 26 each arranged to represent the state (context) of a different respective one of the threads to be executed concurrently; a shared execution pipeline 13 that is common to the concurrently executed threads; and a scheduler 24 for scheduling the concurrent threads for execution through the shared pipeline in an interleaved manner, preferably in a round robin manner. FIG. 4 illustrates an example as to how the threads may be scheduled for execution in the processing unit 10. The processing unit 10 is connected to a shared instruction memory 12 common to the plurality of threads, and a shared data memory 22 that is again common to the plurality of threads.

The execution pipeline 13 comprises a fetch stage 14, a decode stage 16, and an execution stage 18 comprising an execution unit which may perform arithmetic and logical operations, address calculations, load and store operations, and other operations, as defined by the instruction set architecture.

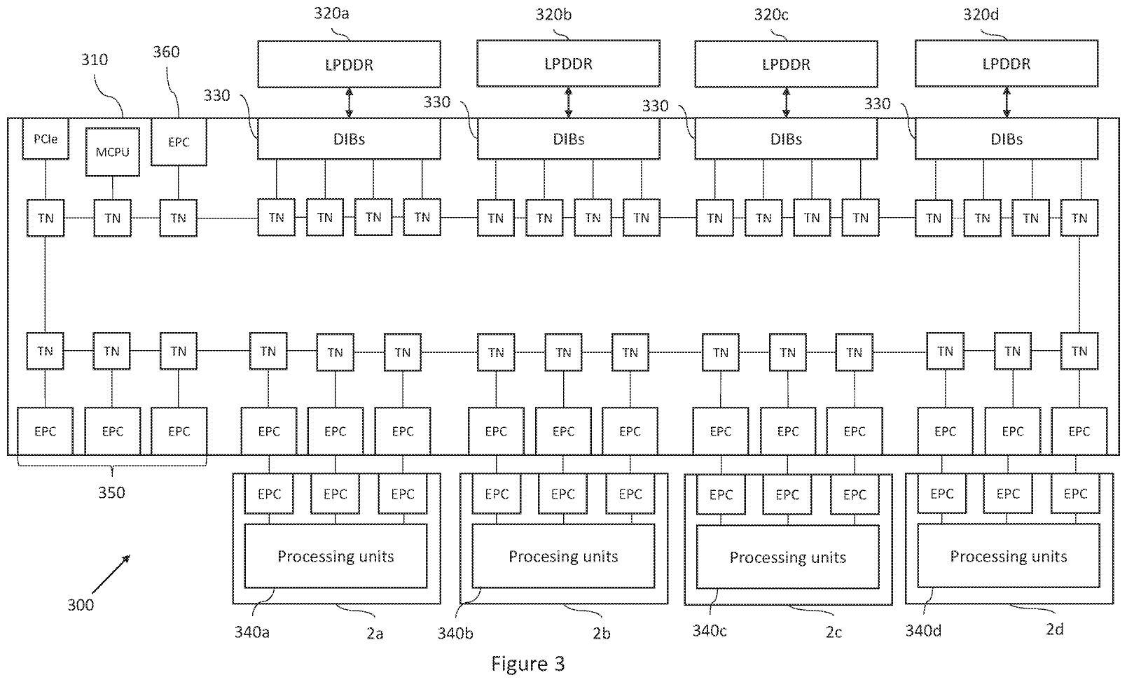

Reference is made to FIG. 3, which illustrates an example of a system 300 according to example embodiments. The system 300 comprises chips 2a-2d, each including one of the processing units 340a-d. Each of the chips 2a-2d may take the form of chip 2 described above with respect to FIG. 1, in which case, each of the processing units 340a-d corresponds to the processing unit 6 and comprises multiple tiles 4. In this case, references to operations (e.g. sending a request, receiving a notification, accessing memory) being performed by one of the processing units 340a-d are to be understood as being references to operations performed by a tile 4 of that processing unit 340.

The system 300 also comprises a further chip 310, which is referred to herein as the fabric chip 310. The fabric chip 310 enables communication between the processing units 340 in the system 300 and other devices in the system 300. In particular, the fabric chip 310 enables a processing unit 340 to access memory of memory devices 320, to communicate with a host system via a PCIe interface, and to communicate with other processing units 340.

The fabric chip 310 includes a number of interface controllers for communication with other chips (i.e. chips 2 or other instances of the fabric chip 310). These are shown in FIG. 3 as EPCs (‘Ethernet Port Controllers’) and provide for the dispatch of packets between chips in ethernet frames. Each of the chips 2 also includes such interface controllers for communicating with the fabric chip 310. As shown, each chip 2a-2d has multiple interface controllers for communicating with the fabric chip 310, which permits multiple tiles 4 of a processing unit 340a-d to send or receive data with the fabric chip 310 at the same time. In addition to the EPCs for communicating with the attached chips 2a-d, the fabric chip 310 further comprises a set of EPCs 350 for communicating with other fabric chips within a group (a ‘POD’) of chips, and an EPC 360 for connection to external ethernet switches of an ethernet network, enabling different groups of chips 2 to communicate in order to scale the system.

The fabric chip 310 comprises a network on chip (NOC) for transferring packets between the different interfaces of the chip 310. In embodiments, the NOC is a circular interconnect comprising a plurality of interconnected trunk nodes, which are each labelled ‘TN’ in FIG. 3. Packets traverse the interconnect, by passing from one trunk node to the next, where they are subject to arbitration and routing at each trunk node.

FIG. 3 shows a number of memory devices 320a-d connected to the fabric chip 310. In the example embodiment shown in FIG. 3, each of the memory devices 320a-d comprises Low-Power Double Data Rate (LPDDR) memory. However, a different type of memory could be used. In the example embodiment shown in FIG. 3, the fabric chip 310 comprises a plurality of memory controllers 330—shown as DIBs (DDR interface bridges)—which provide an interface between the trunk nodes and the LPDDR memory. The memory controllers 330 provides an interface, enabling the processing units 340 to access the memory devices 320. The memory controllers 330 receive memory read and write request packets originating from the processing units 340, where those requests are to read or write from the memory of the associated memory devices 320. In response to read requests, the memory controllers 330 return read completions containing the requested data. Each of the memory controllers 330 comprises a lock manager. Each lock manager maintains a set of variables (referred to as ‘lock variables’) used to control access to different buffers of its associated memory device 320. In addition to the handling of memory read and write requests from the processing units 340, each of the memory controllers 330 also handles requests for managing the set of lock variables stored by that memory controller 330.

Reference is made to FIG. 4, which illustrates a memory controller 400 and components within the memory controller 400 for handling requests originating from processing units 340. In embodiments, each of the memory controllers 330 shown in FIG. 3 is an instance of memory controller 400. The memory controller 400 has an input interface (shown as ‘Slink in’) for receiving packets (referred to as ‘Slink’ packets) from the trunk node to which it is attached. These packets may originate from one of the processing units 340a-340d attached to the chip 310 or from a processing unit 340 attached to another fabric chip. The memory controller 400 has an output interface (shown as ‘Slink out’) for outputting packets to the memory controller's 400 trunk node. The memory controller 400 may output packets to one of the processing units 340a-340d attached to the chip 310 or to a processing unit 340 attached to another fabric chip.

When a packet is received at the memory controller 400, the action taken depends upon the type of the packet. If the packet is a memory read or write request, the packet is processed by protocol conversion circuitry 430. The protocol conversion circuitry 430 converts the memory read or write request from the Slink protocol (used for data plane traffic on the fabric chips) to the AXI protocol and provides the converted packet to the memory device 320 associated with the memory controller 400. Therefore, the memory request is processed either to write data to memory of the respective memory device 320 (if the request is a write) or return a read completion comprising data read from the memory of the respective memory device 320 (if the request is a read). If the packet type (i.e. it is a lock management request) relates to the lock variables for controlling access to the memory of the memory device 320, the packet is provided to the lock manager 410. These lock management requests are first queued in the input FIFO 420, prior to being processed by the lock manager 410. The lock manager 410 has access to a locks table 440 held in storage of the memory controller 400. The locks table 440 stores a plurality of variables (referred to herein as lock variables), each of which is associated with and is used for controlling access to a particular buffer of the memory device 320. Each of the variables is a non-binary variable, i.e. it has more than two possible values. In embodiments, each of the variables is 32-bits in length. This permits the implementation of software for a plurality of thread synchronization primitives like, but not limited to, locks, semaphores, barriers, condition variables etc. The lock manager 410 comprises circuitry for managing the variables in the locks table 440 in response to the lock management requests received from the processing units 340.

Although FIG. 4 shows the locks table 440 being implemented in a dedicated storage (e.g. an SRAM), with dedicated circuitry 410 for managing the variables in that storage, in other embodiments, the variables of locks table 440 could be held in the same memory (e.g. DRAM) of the respective one of the memory devices 320 that also stores application data accessed by the memory read and write requests from the processing units 340.

Each lock management request is issued by a processing unit 340 in the form of a packet, which is routed on the fabric chip 310 to a memory controller 330, where it is serviced by a lock manager 410. A number of lock management request types may be issued by the processing units 340 and are supported by the lock manager 410. Some of these request types are requests for atomic operations to be performed with respect to one of the lock variables. Such operations are atomic, since the lock manager 410 completes each one prior to performing a subsequent one of the operations with respect to the same variable. In other words, there is no interleaving of the operations. Each of the request types includes the destination address of one of the lock variables stored in the table 440 that is targeted by the request. The supported atomic request types include a read, a write, a swap, a fetch and add, a compare and swap. In response to receipt of a read request, the lock manager 410 returns to the processing unit 340 that issued the read request, a read completion containing the value of the targeted variable. A write request contains a value to be written to the target location in the lock table 440. In response to the write request, the lock manager 410 causes the current lock variable at the target location to be overwritten with the value contained in the write request. A swap request is the same as a write, but the lock manager 410 causes the original value of the variable that is overwritten to be returned to the processing unit 340 that issued the swap request. A fetch and add request contains a value to add to the targeted lock variable. In response to a fetch and add request, the lock manager 410 adds the value contained in the request to the variable targeted by the request. The original value of the variable is overwritten by the result of the addition. A compare and swap request contains a compare value and a swap value. In response to a compare and swap request, the lock manager 410 compares the compare value to the lock variable targeted by the request. If the two compared values are equal, the lock manager 410 overwrites the original lock variable with the swap value.

A new type of lock management request is supported by the lock manager 410 and is referred to as a read and notify request. This request specifies a condition in relation to a variable at the location targeted by the request, and causes the lock manager 410 to first determine whether or not the condition is met. A read and notify request packet includes a compare value to which the targeted variable is compared by the lock manager 410 to determine whether or not the condition is met. If the condition is met, the lock manager 410 returns a notification to the processing unit 340 that issued the read and notify request. If the condition is not met, the lock manager 410 registers a notification request associated with the targeted variable, whilst the processing unit 340 that issued the read and notify request waits for a notification. When the targeted variable is updated by a further processing unit 340 to meet the condition, a notification is then returned to the waiting processing unit 340. In this way, the waiting processing unit 340 is not required to poll the lock manager 410 to determine whether it may access the memory buffer, but is informed as soon as the variable is updated. This reduces the latency associated with accessing the memory and reduces the total amount of traffic in the fabric chip 310.

The read and notify request is provided according to different subtypes. These different subtypes are associated with different conditions in relation to the variable targeted by the request.

According to a first subtype, the condition specified by the read and notify request is that the targeted variable is equal to the compare value specified in the request. In this case, if the targeted variable is equal to the compare value, the lock manager 410 returns to the processing unit 340 that issued the request, the original value of the targeted variable. This serves as a notification to the requesting processing unit 340 that the variable is equal to the compare value it dispatched and, therefore, that it may access the associated memory buffer. If the two compared values are not equal, the lock manager 410 waits until the value of the variable changes. The value of the variable may be changed by the lock manager 410 in response to one of the other types of lock management request discussed above—e.g. write, swap, fetch and add—being issued by another one of the processing units 340. When the value of the targeted variable changes to be equal to the compare value, the lock manager 410 issues a notification to the processing unit 340 that issued the read and notify request. The notified processing unit 340 then may proceed to access the memory buffer.

For a second subtype of the read and notify request, the condition specified by the read and notify request is that the targeted variable is not equal to a compare value specified in the request. In this case, if the targeted variable is not equal to the compare value, the lock manager 410 returns to the processing unit 340 that issued the request, the original value of the targeted variable. This serves as a notification to the requesting processing unit 340 that the lock variable is not equal to the compare value it dispatched and, therefore, that it may access the associated memory buffer. If the two compared values are equal, the lock manager 410 waits until the value of the variable changes. The value of the variable 530 may be changed by the lock manager 410 in response to one of the other types of lock management request discussed above—e.g. write, swap, fetch and add—being issued by another one of the processing units 340. When the value of the targeted variable changes such it is no longer equal to the compare value, the lock manager 410 issues a notification to the processing unit 340 that issued the read and notify request. That processing unit 340 then may proceed to access the memory buffer 510.

For a third subtype of the read and notify request, the lock manager 410, after having registered a notification request in response to the read and notify request, returns a notification packet to the requesting processing unit 340 in response to any change in the targeted lock variable.

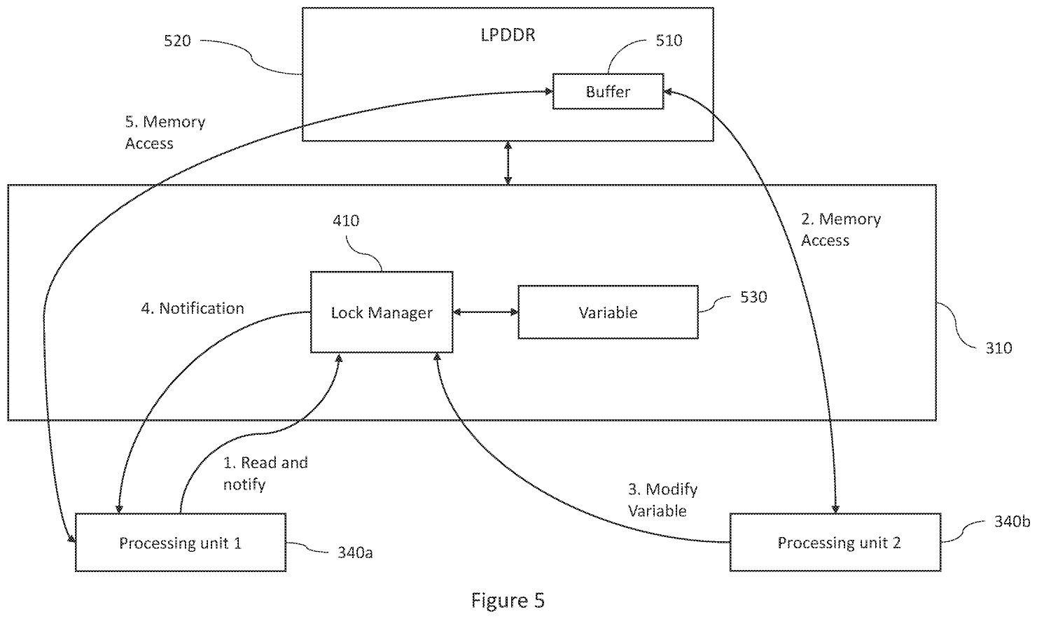

Reference is made to FIG. 5, which illustrates an example of how the read and notify request may be used as part of a process for synchronising the processing units 340a, 340b of the system 300. FIG. 5 shows a simplified view of the system 300 shown in FIG. 3. The memory buffer 510 is part of one of the memory devices 320, and the lock manager 410 and the variable 530 belong to one of the memory controllers 330. A lock variable 530 is shown stored in a storage of the fabric chip 310. The lock variable 530 is stored in one of the entries of the locks table 440 shown in FIG. 4. The lock variable 530 is associated with the buffer 510 and is used by the processing units 340a-b to determine when the processing unit 340a may access this buffer 510. The value of the lock variable 530 indicates whether or not the first processing unit 340a may access the buffer 510.

As shown in FIG. 5, the processing unit 340a issues a read and notify request packet (shown as “1. Read and notify”) to the lock manager 410. This read and notify request contains a compare value associated with the processing unit 340a and indicates the position in a sequence in which the processing unit 340a is to access the buffer 510. The read and notify request expresses a condition associated with the compare value. The lock manager 410 responds to this request by comparing the compare value contained in the request to the value of the variable 530. In response to determining that the variable 530 does not meet the condition (e.g. is not equal to the compare value), the lock manager 410 registers a notification request associated with the variable 530. Registering the notification request associated with the variable 530 comprises storing information in the locks table 440 derived from the read and notify request, including the compare value and the address of the processing unit 340a that issued the request.

The second processing unit 340b issues one or more memory access request packets (shown as “2. Memory Access”) to access buffer 510 of memory 520. The processing unit 340b may proceed to access the buffer 510 without first checking the value of the variable 530, since the processing unit 340b is scheduled to be the first of the two processing units 340a, 340b to access the buffer 510, and the variable 530 is used to provide a barrier preventing access by processing unit 340a, until processing unit 340b has completed its operations with respect to buffer 510.

The memory access requests issued at “2. Memory Access” include one or more write request packets and may include one or more read request packets. The memory access may be performed by processing unit 340b to write data to the buffer 510 for transfer to the processing unit 340a. Alternatively, the memory access requests may include both memory read and write requests that form part of a read-modify-write operation performed on data in the buffer 510. When performing the read-modify-write operation, the processing unit 340b issues a memory read request to read an item of data from the buffer 510, performs an operation on that item of data (e.g. adding it together with another item to data) to generate a resulting item of data, and writes back the resulting item of data to the buffer 510. In either case, these operations to access the buffer are atomic and must be completed before another processing unit 340 is permitted to access the same part of the buffer 510.

Although FIG. 5 shows that the processing unit 340a issues its read and notify request prior to the memory access by processing unit 340b, the read and notify request could be issued after commencement of the memory access (e.g. after issuance of a write request) by processing unit 340b.

After it has completed its access to memory, the processing unit 340b then issues a request (shown as “3. Modify variable”) to update the variable 530. This request causes the variable 530 to be updated to meet the condition (e.g. to be equal to the compare value) specified by the read and notify request issued by processing unit 340a. The lock manager 410, in response to the change to the variable 530 issues a notification (shown as “4. Notification”) to the processing unit 340a. If the read and notify request is of the first or second subtype discussed above, when the value of the variable 530 changes, the lock manager 410 first checks the new value of the variable 530 against the compare value from the read and notify request, and only issues the notification to processing unit 340a upon determining that the variable meets the condition in relation to the compare value (e.g. is equal to the compare value). The processing unit 340a, responsive to the notification, issues memory access requests (shown as “5. Memory Access”) to access the buffer 510. These memory access requests comprise read requests to access the data stored in the buffer 510 by the processing unit 340b.

As described above, the compare value dispatched in the read and notify request by processing unit 340a indicates the position in a sequence in which the processing unit 340a is to access the buffer 510. For example, if the processing unit 340a is the second in a sequence of processing units 340a,b to access the buffer 510, the processing unit 340a may issue a read and notify request of the first subtype with a compare value of ‘1’. Initially, at the start of the sequence of operations shown in FIG. 5, the variable may be set to a value of ‘0’. After completing, its access to buffer 510, the processing unit 340b may issue a fetch and add request (3. Modify Variable) to cause the lock manager 410 to increment the value of variable 530, such that it is then equal to ‘1’. Since the variable 530 is then equal to the compare value, this indicates that it is now the processing unit's 340a turn to access the buffer 510, and the lock manager 410 dispatches the notification (4. Notification) to the processing unit 340a.

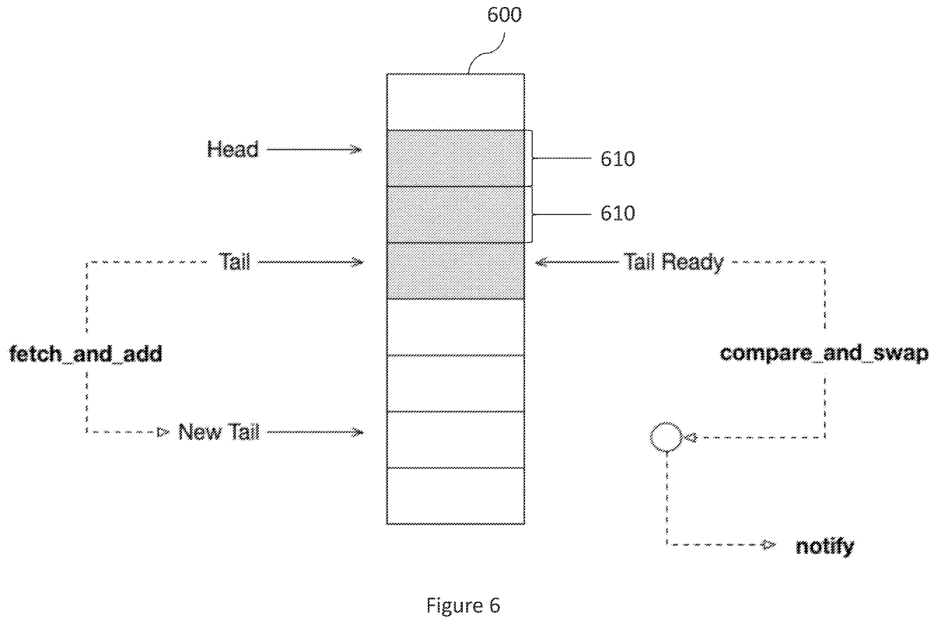

FIG. 5 illustrates an example in which the synchronisation scheme is used to synchronise two processing units 340a-b. The synchronisation scheme disclosed herein could also be used to synchronise a plurality of writing processing units with a reading processing unit. Reference is made to FIG. 6, which illustrates an example of a buffer 600 belonging to memory of one of the memory devices 320a-d. The buffer 600 is shown divided into a plurality of parts 610. Each of the parts 610 is written to by a different processing unit 340. FIG. 6 shows head and tail pointers, which indicate which portions of data in the queue are ready to be read. In order to synchronise write and read access to the buffer 600, these pointers are provided as variables in the lock table 440. Two tail pointers (‘Tail’ and ‘Tail Ready’) are provided in order to allow for concurrent access to the buffer 600 and to prevent one processing unit 340 from marking a part 610 that is being written to by another processing unit 340 as ready to be read.

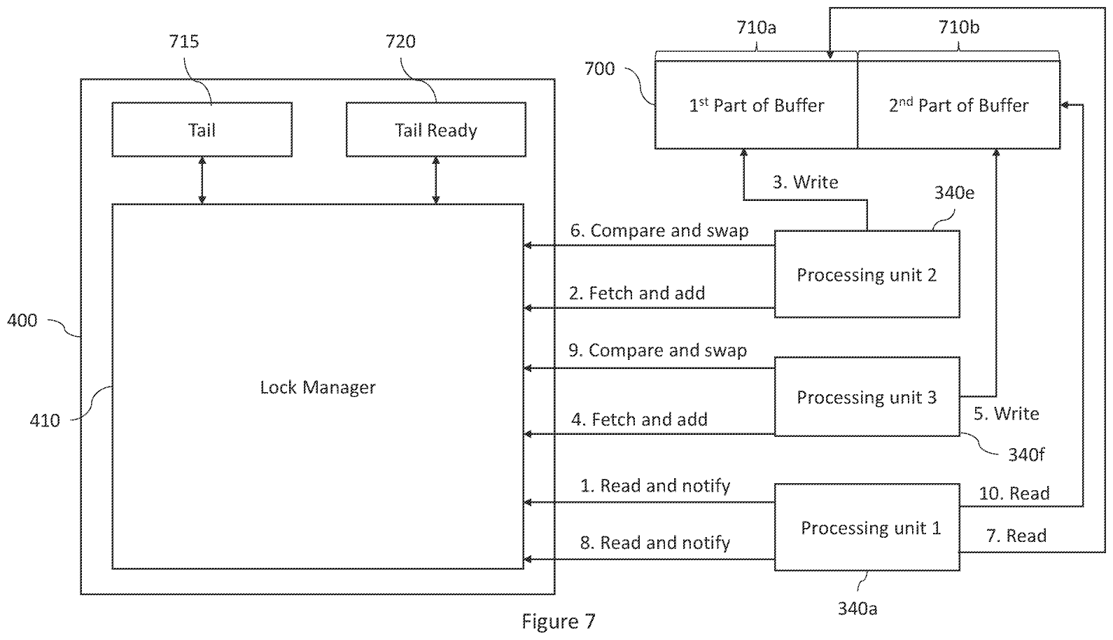

Reference is made to FIG. 7, which illustrate a series of requests that may be issued by a set of processing units 340a,e,f to exchange data via a memory buffer 700, which is part of a memory device 320. The processing units 340e,f may be remote processing units, which are attached to a fabric chip that is different to the fabric chip 310 to which processing unit 340a is attached. The processing units 340e,f are configured to write data to the buffer 700, prior to that data being read from buffer 700 by the processing unit 340a. In order to synchronise this process, such that processing unit 340a does not commence reading a particular part of the buffer 700 until the relevant one of the processing units 340e,f has finished writing its data to that part of the buffer 700, the following steps are performed.

In the memory interface 400 of the fabric chip 310 are shown two lock variables, which are the tail pointer 715 and the tail ready pointer 720. The tail pointer 715 indicates the number of processing units 340e,f that have commenced writing to the buffer 700. The tail ready pointer 720 indicates the number of processing units 340e,f that have completed writing to the buffer 700. The processing unit 340a is to commence reading from a particular part 710 of the buffer 700 once the tail ready pointer 720 indicates that writing to that part 710 of the buffer 700 is complete. Initially, both the tail pointer 715 and tail ready pointers 720 are set equal to the head pointer (not shown in FIG. 7).

Processing unit 340a issues a read and notify request packet (shown as “1. Read and notify”) to the lock manager 410. This read and notify request is a first subtype of read and notify request. The read and notify request identifies the tail ready variable 720, which is held in storage of the memory interface 400, as the targeted value. The compare value in the request indicates the value to be taken by the tail ready variable 720 when one of the processing units 340f,e has finished its writing to the buffer 700. This compare value may be a pointer to the end of the first part 710a of the buffer 700. The compare value may be set equal to the number of processing units 340e,f (in this case two) that are to write to the buffer 700. In response to the read and notify request, the lock manager 410 registers the request in association with the tail ready variable 720.

The processing unit 340e issues a fetch and add request (2. “Fetch and add”) to update the tail pointer 715. The lock manager 410 returns the current value of the tail pointer 715 to the processing unit 340e, and increments the tail pointer 715 to a new value. The new value of the tail pointer 715 points to the end of the first part 710a of the buffer 700, which is also the start of the second part 710b of the buffer 700. The processing unit 340e, upon receipt of the response to the fetch and add request, issues write requests (shown as “3. Write”) to write its data to the first part 710a of the buffer 700.

The processing unit 340f also issues a fetch and add request (shown as “4. Fetch and add”) to the lock manager 410. The lock manager 410, in response to this request, returns the value of the tail pointer 715, which after being updated by the processing unit 340e points to the start of the second part 710b of the buffer 700. The lock manager 410 also, in response to the fetch and add request, increments the tail pointer 715 to point to the end of the second part 710b of the buffer. The processing unit 340f, upon receipt of the response to its fetch and add request, issues write requests (show as “5. Write”) to write its data to the second part 710b of the buffer 700. The processing unit 340f writes this data to the start of the second part 710b, which is identified by the value of the tail pointer 715 returned in response to the fetch and add request.

Once the processing unit 340e has completed its writing to the first part 710a, that processing unit 340e issues a compare and swap request (shown as “6. Compare and swap”) to the lock manager 410. This compare and swap request targets the tail ready pointer 720. The compare and swap comprises the initial value of the tail pointer 715 that was returned in response to the fetch and add request (2. Fetch and add) as the compare value, and the incremented value (resulting from the fetch and add operation) of the tail pointer 715 as the swap value. The lock manager 410 compares the compare value to the tail ready pointer 720 and, in response to determining that these values match, overwrites the current tail ready pointer value 720 with the swap value in the request.

In response to the update to the tail ready pointer 720, the lock manager 410 determines that the tail ready pointer 720 is equal to the compare value associated with the registered notification request, and in response, issues a notification to the waiting processing unit 340a. This notification provides an indication to the waiting processing unit 340a that the writing to the first part 710a of the buffer 700 is complete and that the processing unit 340a may read the data from this part 710a. The processing unit 340a then responds by issuing read requests (shown as “7. Read”) to read the data from the first part 710a of the buffer 700. The processing units 340a reads the data starting from the location in the buffer 700 indicated by the header pointer. The processing unit 340a then dispatches a further read and notify request (shown as “8. Read and notify”) targeting the tail ready pointer 720. This read and notify request is also a first subtype of read and notify request. The compare value in this second read and notify request points to the end of the second part 710b of the buffer 700. If the tail ready pointer 720 is not yet updated to point to the end of the second part 710b, the lock manager 410 waits until the tail ready pointer 720 changes.

When the processing unit 340f has completed writing its data to the second part 710b of the buffer 700, it issues a compare and swap request (shown as “9. Compare and swap”) to the lock manager 410. This compare and swap request targets the tail ready pointer 720. The compare and swap comprises the value of the tail pointer 715 that was returned in response to the fetch and add request (4. Fetch and add) as the compare value, and the incremented value of the tail pointer 715 (resulting from the fetch and add operation) as the swap value. The lock manager 410 compares the compare value to the tail ready pointer 720 and, in response to determining that these values match, swaps the tail ready pointer 720 value for the swap value in the request.

In response to the update to the tail ready pointer 720, the lock manager 710 determines that the tail ready pointer 720 is equal to the compare value provided in the second read and notify request (8. Read and notify), and in response, issues a notification to processing unit 340a. In response, processing unit 340a issues read requests (shown as “10. Read”) to read the data stored in the second part 710b of the buffer 700.

In this example, the writing to the buffer 710a-b by the two processing units 340e-f is not synchronised, and so either could begin and/or complete its writing to a part of the buffer 700 first. The scheme enables the transfer of data by synchronising the reading by processing unit 340a with the writing by processing units 340e-f.

In the example described, the processing unit 340a commences reading data from the buffer 700 when one of the processing units 340e-f has completed writing to the buffer, even if writing to the buffer 700 by all processing units 340e-f is not complete. This is enabled by use of the compare and swap operation, which prevents the tail ready pointer being set to mistakenly mark other parts 710 of the buffer 700 as being ready to be read. In an alternative embodiment, where the processing unit 340a waits until all data has been written to buffer 700 before commencing reading, the processing units 340a-b may instead issue fetch and add requests (in place of “6. Compare and swap” and “9. Compare and swap”) to update the tail ready pointer 720.

Examples have been described with respect to FIGS. 5 and 7 as to how a lock variable (e.g. variable 530 or variables 715, 720) may be used to synchronise access to a buffer (e.g. buffer 710 or buffer 510). As discussed above with respect to FIG. 3, each fabric chip 310 stores multiple such lock variables, each of which may be used to synchronise access to a different buffer in one of memory devices 320a-d. These different variables may be used to simultaneously synchronise access to different buffers by the same or different processing units 340a-b. For example, whilst lock manager 410 is synchronising the accesses by processing units 340a-b to buffer 510 as described with respect to FIG. 5, circuitry (belonging to a same or different lock manager 410) of the fabric chip 310 may, in the same manner, synchronise accesses by processing units 340a-b to a different buffer in one of the memory devices 320a-d. The accesses by these processing units 340a-b to the different buffer may be carried out by different tiles 4 of the processing units 340a-b to those accessing buffer 510.

It has been described that the processing units 340 may issue requests for operations (e.g. read and notify, fetch and add, compare and swap) to be performed on lock variables. The values included in these requests, which determine the order in which the processing units 340 access buffers 510, 700, is determined in dependence upon values included in the sets of compiled code for running on the processing units 340.

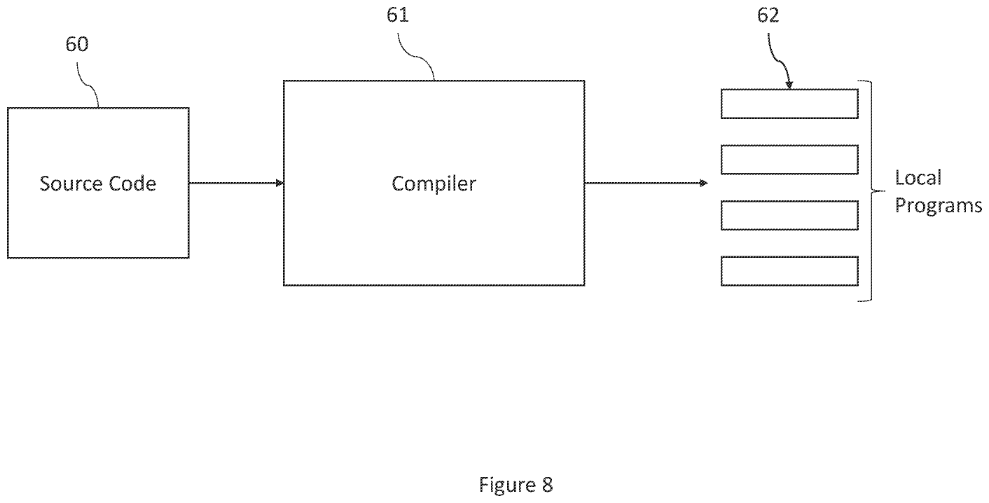

Reference is made to FIG. 8, which illustrates how local programs 62 for an application are generated by a compiler 61. The compiler 61 receives source code 60 for the application. The application may be a machine learning application, e.g. for training a neural network. The compiler 61 generates from the source code 60, a set of local programs 62, where each of these is for running on a separate processing unit (e.g. on a separate tile 4). For each access made to a particular buffer (e.g. buffer 510) in one of the memory devices 320, the local programs include an indication that the associated lock variable (e.g. variable 530) must take for its processing unit to be permitted to carry out that access to the buffer. Each such indicated value is dispatched as the compare value in a read and notify request. Each local program accessing such a buffer also includes one or more instructions for issuing requests (e.g. fetch and add) to update the value of the lock variable, so that the next processing unit in a sequence may access the buffer. In this way, the local programs are compiled to provide control over the order in which the processing units access the buffers of memory devices 320.

The above described method for synchronising access to shared memory may be used as a fine grained synchronisation method, in combination with an additional synchronisation technique for synchronising processors. One such additional synchronisation technique that has been implemented for the processing unit 6 described herein makes use of a 3-phase iterative execution model: Compute, Barrier, and Exchange. The implications are that data transfer to and from a processor is usually barrier dependent to provide data-consistency between the processors and between each processor and an external storage. Typically used data consistency models are Bulk Synchronous Parallel (BSP), Stale Synchronous Parallel (SSP) and Asynchronous. The processing units 6 described herein uses a BSP model, but it will be apparent that the other sync models could be utilised as an alternative.

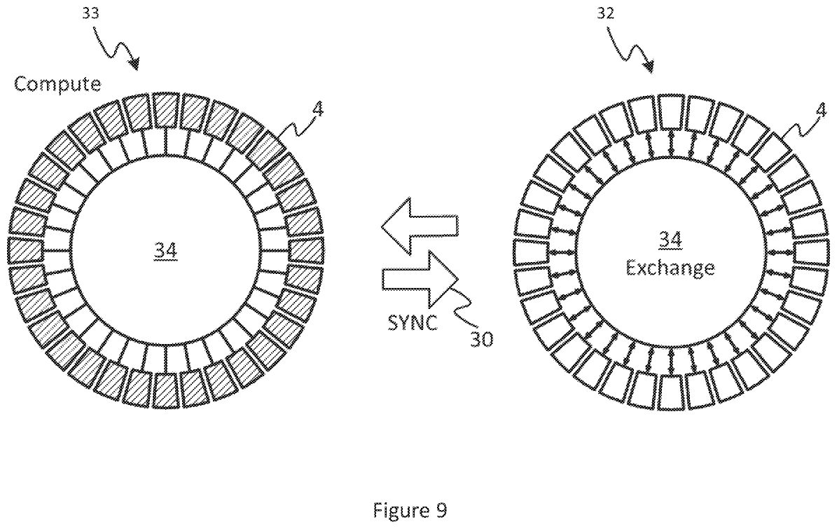

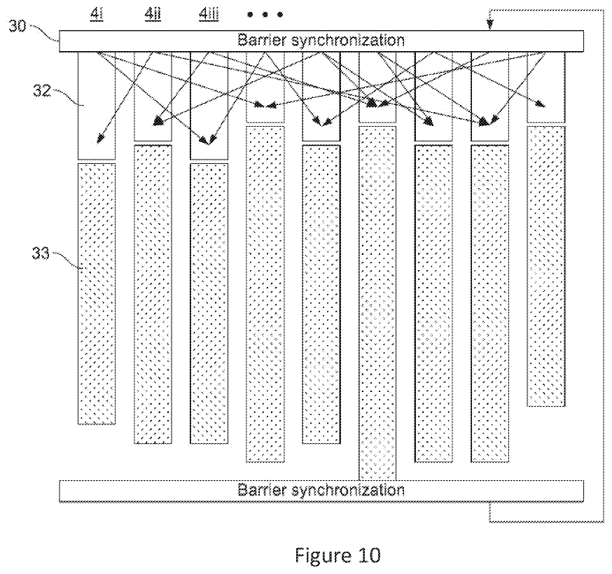

Reference is made to FIGS. 9 and 10, which illustrate an implementation of a BSP exchange scheme in which each tile 4 performs a compute phase 33 and an exchange phase 32 in an alternating cycle, separated from one to the other by a barrier synchronization 30 between tiles 4. In the case illustrated by FIGS. 9 and 10, a barrier synchronization 30 is placed between each compute phase 33 and the following exchange phase 32. During the compute phase 33, each tile 4 performs one or more computation tasks locally on-tile, but does not communicate any results of these computations with any others of the tiles 4. In the exchange phase 32, each tile 4 is allowed to exchange one or more results of the computations from the preceding compute phase to and/or from one or more others of the tiles 4, but does not perform any new computations until it has received from other tiles 4 any data on which its task(s) has/have dependency. Neither does it send to any other tile 4, any data except that computed in the preceding compute phase. It is not excluded that other operations such as internal control-related operations may be performed in the exchange phase 32. The communication external to the tile group may optionally utilise the BSP mechanism, but alternatively may not utilize BSP and may instead use some other synchronization mechanism of its own.

According to the BSP principle, a barrier synchronization 30 is placed at the juncture transitioning from the compute phase 33 into the exchange phase 32, or the juncture transitioning from the exchange phase 32 into the compute phase 33, or both. That is to say, either: (a) all tiles 4 are required to complete their respective compute phases 33 before any in the group is allowed to proceed to the next exchange phase 32, or (b) all tiles 4 in the group are required to complete their respective exchange phases 32 before any tile 4 in the group is allowed to proceed to the next compute phase 33, or (c) both of these conditions are enforced. In all three variants, it is the individual tiles 4 which alternate between phases, and the whole assembly which synchronizes. The sequence of exchange and compute phases may then repeat over multiple repetitions. In BSP terminology, each repetition of exchange phase and compute phase is sometimes referred to as a “superstep” (though note that in the literature the terminology is not always used consistently: sometimes each individual exchange phase and compute phase individually is called a superstep, whereas elsewhere, as in the terminology adopted herein, the exchange and compute phases together are referred to as a superstep).

FIG. 10 illustrates the BSP principle as implemented amongst a group 4i, 4ii, 4iii of some or all of the tiles 4 in the array 6, in the case which imposes: (a) a barrier synchronization from compute phase 33 to exchange phase 32 (see above). Note that, in this arrangement, some tiles 4 are allowed to begin computing 33 whilst some others are still exchanging.

It is understood, therefore, that the BSP model is used for exchange of data between tiles 4 on the processing unit 2. Additionally, the BSP model may also be used for the exchange of data between processing units 2.

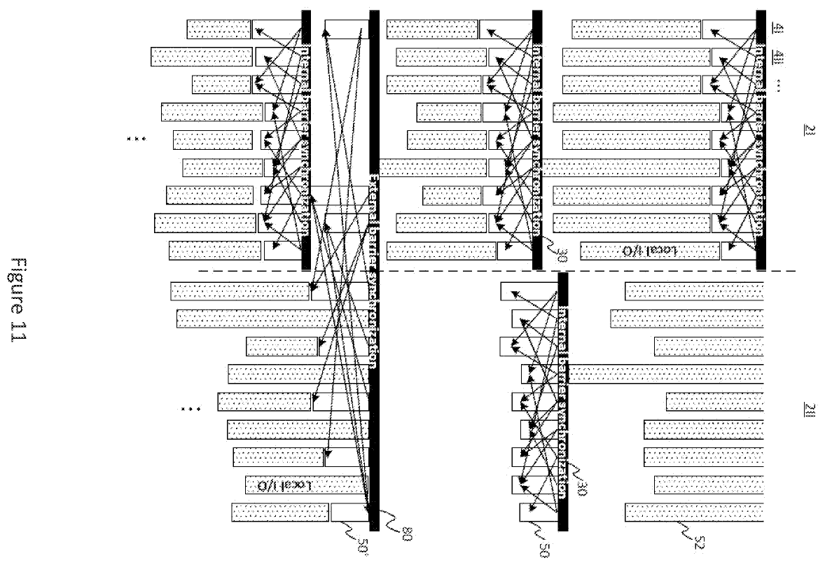

Reference is made to FIG. 11, which illustrates an example BSP program flow involving both internal (on-chip) and external (inter-chip) synchronizations. As shown, the flow comprises internal exchanges 50 (of data between tiles 4 on the same chip 2) and an external exchange 50′ (of data between tiles 4 on different chips 2). The program flow in FIG. 11 illustrates a program flow for a first processing unit 2i and a second processing unit 2ii.

As illustrated in FIG. 11, the internal BSP supersteps (comprising the internal exchanges 50 of data between tiles 4 on the same chip 2) are kept separate from the external sync and exchange (comprising the external exchanges 50′ of data between tiles 4 on different chips 2).

The program may be arranged to perform a sequence of synchronizations, exchange phases and compute phases comprising, in the following order: (i) a first compute phase, then (ii) an internal barrier synchronization 30, then (iii) an internal exchange phase 50, then (iv) an external barrier synchronization 80, then (v) an external exchange phase 50′. The external barrier 80 is imposed after the internal exchange phase 50, such that the program only proceeds to the external exchange 50′ after the internal exchange 50. Note also that, as shown with respect to chip 21 in FIG. 11, optionally a compute phase may be included between internal exchange (iii) and external barrier (iv).

This overall sequence is enforced by the program (e.g. being generated as such by the compiler). In embodiments, the program is programmed to act in this way by means of a SYNC instruction executed by the tiles 4. The internal synchronization and exchange does not extend to any tiles 4 or other entities on another chip 2. The sequence (i)-(v) (with the aforementioned optional compute phase between iii and iv) may be repeated in a series of overall iterations. Per iteration there may be multiple instances of the internal compute, sync and exchange (i)-(iii) prior to the external sync & exchange. i.e. multiple instances of (i)-(iii) (retaining that order), i.e. multiple internal BSP supersteps, may be implemented before (iv)-(v), i.e. the external sync and exchange. Note also, any of the tiles 4 may each be performing their own instance of the internal synchronization and exchange (ii)-(iii) in parallel with the other tiles 4.

Thus per overall BSP cycle (i)-(v) there is at least one part of the cycle (ii)-(iii) wherein synchronization is constrained to being performed only internally, i.e. only on-chip.

Note that during an external exchange 50 the communications are not limited to being only external: some tiles 4 may just perform internal exchanges, some may only perform external exchanges, and some may perform a mix.

Also, as shown in FIG. 11, some tiles 4 may perform local input/output during a compute phase. For example, they may exchange data with a host or other type of external storage.

Note also that, as shown in FIG. 11, it is in general possible for any or all tiles to have a null compute phase 52 or a null exchange phase 50 in any given BSP superstep.

The BSP synchronisation scheme involving alternating compute and exchange phases may be combined with the synchronisation scheme described herein using the lock variable. In this case, an additional synchronisation barrier, which is controlled by the lock variable, is provided in the exchange phase.

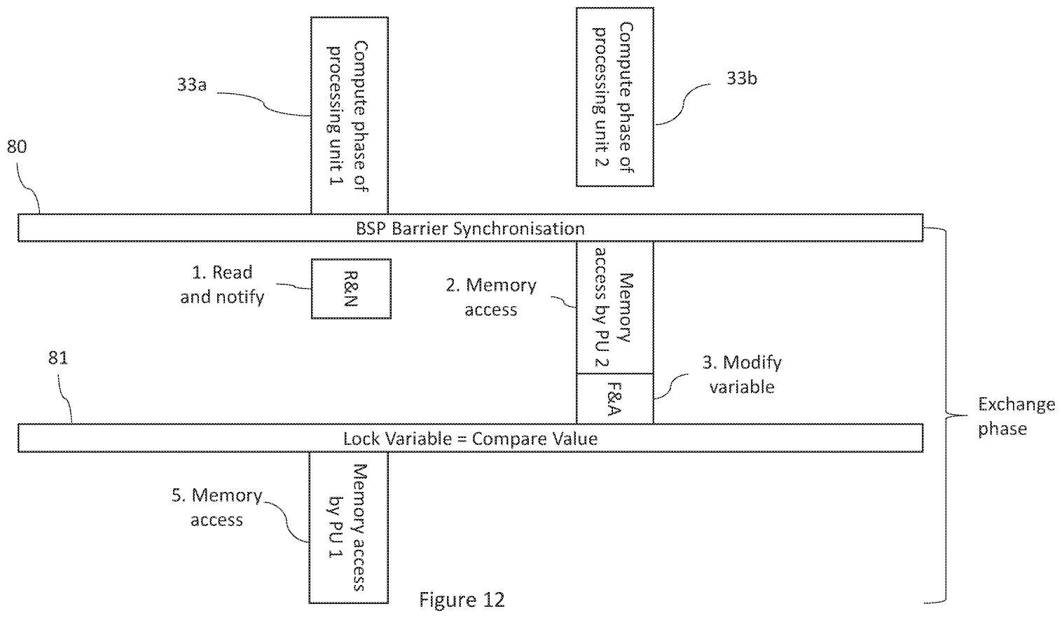

Reference is made to FIG. 12, which illustrates a program flow showing a combination of the two synchronisation schemes for the processing units 340a, 340b. The program flow illustrates a compute phase 33a of processing unit 340a, a compute phase 33b of processing unit 340b and an exchange phase for both of the processing units 340a, 340b. The operations discussed above with respect to FIG. 5 are performed during the exchange phase.

Separating the compute phases 33a, 33b from the exchange phase is a BSP barrier synchronisation 80. Following this barrier synchronisation 80, and during the exchange phase, the processing unit 340a issues a read and notify request (1. Read and notify) to set a notification request on the lock variable 530. This provides a barrier 81 separating the access to buffer 510 of processing unit 340b from that of processing unit 340a. Following the BSP barrier 80, the processing unit 340b accesses the buffer 510 of memory (2. Memory access). After completing its memory access, processing unit 340b issues a request (3. Modify variable) to update the lock variable to meet the condition specified by the read and notify request. The lock manager 410 responds by issuing a notification to processing unit 340a to cause it to pass the barrier 81 and access the buffer 510 (5. Memory Access).

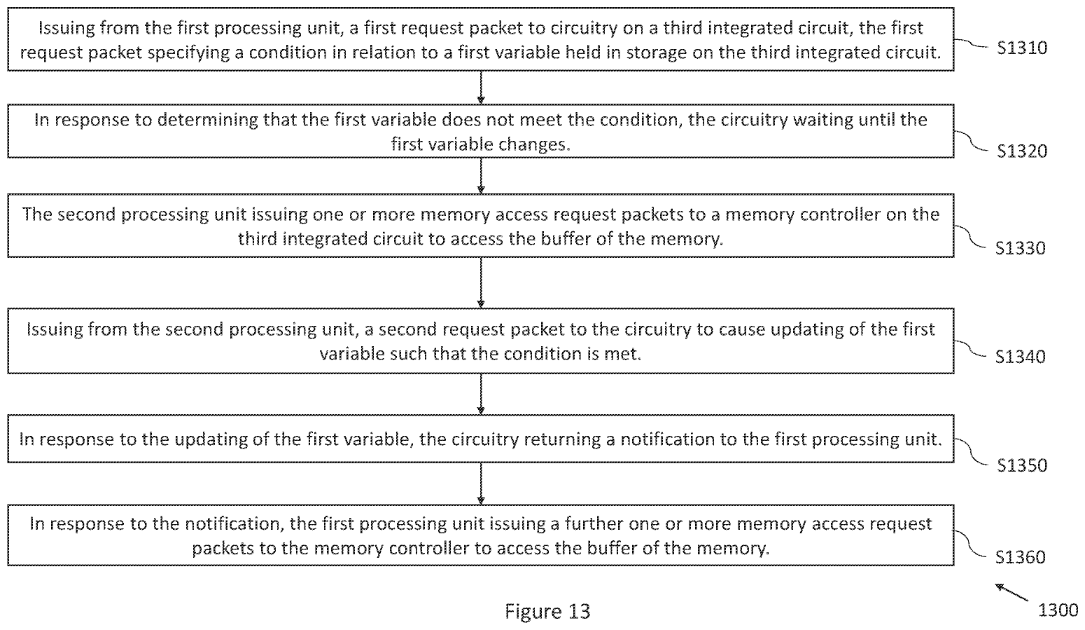

Reference is made to FIG. 13, which illustrates an example of a method 1300 for synchronising access to buffer 510 by processing units 340a, 340b.

At S1310, the first processing unit 340a issues a read and notify request to the lock manager 410, the read and notify request specifying a condition in relation to a first variable held in the lock table 440.

At S1320, in response to determining that the first variable does not meet the condition, the lock manager 410 waits until the first variable changes.

At S1330, the second processing unit 340b issues one or more memory access request packets to a memory controller 330 to access the buffer 510.

At S1340, the second processing unit 340b issues a request to update the first variable, such that the condition is met. In response to this request, the lock manager 410 updates the first variable accordingly.

At S1350, in response to the updating of the first variable, the lock manager 410 returns a notification to the first processing unit 340a.

At S1360, in response to the notification, the first processing unit 340a issues a further one or more memory access request packets to the memory controller 330 to access the buffer 510.

It will be appreciated that the above embodiments have been described by way of example only.

1. A data processing system comprising:
a first integrated circuit comprising a first processing unit;
a second integrated circuit comprising a second processing unit;
a shared memory accessible to the first processing unit and the second processing unit; and
a third integrated circuit comprising:
a memory controller configured to access the shared memory;
a storage holding a first variable configured to control access to a buffer of the shared memory; and
circuitry configured to manage the first variable,
wherein the first processing unit is configured to issue a first request packet to the circuitry, the first request packet specifying a condition in relation to the first variable;
wherein the circuitry is configured to, in response to determining that the first variable does not meet the condition, wait until the first variable changes,
wherein the second processing unit is configured to, prior to the first variable meeting the condition:
issue first one or more memory access request packets to the memory controller to access the buffer of the shared memory; and
subsequently, issue a second request packet to cause updating of the first variable such that the condition is met,
wherein the circuitry is configured to, in response to the updating of the first variable, return a notification to the first processing unit,
wherein the first processing unit is configured to, in response to the notification, issue second one or more memory access request packets to the memory controller to access the buffer of the shared memory.

2. The data processing system of claim 1, wherein the third integrated circuit is configured to interface with both the first integrated circuit and the second integrated circuit via ethernet links.

3. The data processing system of claim 1, wherein the condition in relation to the first variable is that the first variable is equal to a compare value contained in the first request packet.

4. The data processing system of claim 1, wherein the condition in relation to the first variable is that the first variable is not equal to a compare value contained in the first request packet.

5. The data processing system of claim 1, wherein the condition in relation to the first variable is that the first variable is updated to a new value.

6. The data processing system of claim 1, wherein the second request packet comprises a request for an atomic compare and swap operation, the second request packet comprising a compare value and a swap value, the swap value being equal to a first value,
wherein the circuitry for managing the first variable is configured to, in response to the second request packet:
compare a current value of the first variable to the compare value; and
in response to determining that the current value of the first variable is equal to the compare value, set the first variable equal to the first value.

7. The data processing system of claim 6, wherein the second processing unit is configured to, prior to accessing the buffer of the shared memory, issue a request for a fetch and add operation to be performed with respect to a second variable held in the storage,
wherein the circuitry is configured to, in response to the request for the fetch and add operation, return a current value of the second variable to the second processing unit and increment the second variable to set the second variable equal to the first value,
wherein the second processing unit is configured to provide the current value of the second variable as the compare value in the second request packet.

8. The data processing system of claim 1, wherein the second processing unit is configured to access the buffer of the shared memory by writing data to the buffer of the shared memory,
wherein the first processing unit is configured to access the buffer of the shared memory by reading the data from the buffer of the shared memory.

9. The data processing system of claim 1, wherein the data processing system comprises a plurality of further processing units configured to write data to the buffer of the shared memory, the plurality of further processing units including the second processing unit, wherein each of the further processing units is configured to:
write data to a different part of the buffer of the shared memory; and
subsequently, issue a request to cause updating of the first variable.

10. The data processing system of claim 9, wherein the first processing unit is configured to, for each of the different parts of the buffer of the shared memory:
issue a respective request of a first type to the circuitry;
subsequently, receive a respective notification from the circuitry; and
in response to the respective notification, issue one or more read requests to read data from a respective part of the buffer of the shared memory,
wherein the first request packet comprises a first request of the first type,
wherein the circuitry is configured to generate the respective notification in response to the respective request of the first type.

11. The data processing system of claim 1, wherein the first processing unit and the second processing unit are configured to participate in a barrier synchronisation, which separates compute phases of the first processing unit and the second processing unit from an exchange phase of the first processing unit and the second processing unit,
wherein the first processing unit is configured to issue the first request packet and the second one or more memory access request packets during the exchange phase; and
wherein the second processing unit is configured to issue the first one or more memory access request packets and the second request packet during the exchange phase.

12. The data processing system of claim 1, wherein the first processing unit is configured to execute a first set of instructions so as to:
perform computations on a first set of data;
issue the first request packet; and
issue the second one or more memory access request packets, wherein the second processing unit is configured to execute a second set of instructions so as to:
perform computations on a second set of data;
issue the second request packet; and
issue the first one or more memory access request packets,
wherein the first set of instructions and the second set of instructions form part of an application.

13. The data processing system of claim 12, wherein the second processing unit is configured to perform its computations on part of the second set of data to generate part of the first set of data,
wherein the first one or more memory access request packets comprise one or more write requests comprising the part of the first set of data,
wherein the first one or more memory access request packets comprise one or more read request packets, wherein the memory controller is configured to, in response to the one or more read request packets, return the part of the first set of data in one or more read completions.

14. The data processing system of claim 1, wherein the memory controller comprises the circuitry configured to manage the first variable.

15. The data processing system of claim 14, wherein the first variable is a non-binary variable represented by more than two bits.

16. The data processing system of claim 1, wherein the first processing unit is a first tile belonging to a first multi-tile processing unit formed on the first integrated circuit, and wherein the second processing unit is a second tile belonging to a second multi-tile processing unit formed on the second integrated circuit.

17. The data processing system of claim 1, wherein the first variable comprises a pointer identifying a location in the buffer of the shared memory,
wherein the notification comprises a value of the pointer,
wherein the first processing unit is configured to, in response to the notification, issue the second one or more memory access request packets to access the buffer of the shared memory at the location in the buffer.

18. The data processing system of claim 1, wherein the storage comprises a plurality of variables for controlling access to different buffers of the shared memory, the plurality of variables comprising the first variable,
wherein the circuitry is configured to, for each variable of the plurality of variables, implement atomic operations with respect to a respective variable.

19. The data processing system of claim 1, wherein the second integrated circuit is connected to the third integrated circuit by one or more intermediate integrated circuits.

20. A method for synchronising access to a buffer of shared memory by a first processing unit, formed on a first integrated circuit, and a second processing unit, formed on a second integrated circuit, the method comprising:
issuing from the first processing unit, a first request packet to circuitry on a third integrated circuit, the first request packet specifying a condition in relation to a first variable held in storage on the third integrated circuit;
in response to determining that the first variable does not meet the condition, the circuitry waiting until the first variable changes;
prior to the first variable meeting the condition:
the second processing unit issuing a first memory access request packet to a memory controller on the third integrated circuit to access the buffer of the shared memory; and
subsequently, issuing from the second processing unit, a second request packet to the circuitry to cause updating of the first variable such that the condition is met;
in response to the updating of the first variable, the circuitry returning a notification to the first processing unit; and
in response to the notification, the first processing unit issuing a second memory access request packet to the memory controller to access the buffer of the shared memory.

21. The method of claim 20, wherein the condition in relation to the first variable is that the first variable is equal to a compare value contained in the first request packet.

22. The method of claim 20, wherein the condition in relation to the first variable is that the first variable is not equal to a compare value contained in the first request packet.

23. The method of claim 20, wherein the condition in relation to the first variable is that the first variable is updated to a new value.

24. The method of claim 20, wherein the second request packet comprises a request for an atomic compare and swap operation, the second request packet comprising a compare value and a swap value, the swap value being equal to a first value,
the method further comprising, in response to the second request packet:
comparing a current value of the first variable to the compare value; and
in response to determining that the current value of the first variable is equal to the compare value, setting the first variable equal to the first value.
